(19) United States
(12) Patent Application Publication
(10) Pub. No.: US 2026/0105546 A1
(43) Pub. Date: Apr. 16, 2026

(54) METHODS AND SYSTEMS FOR RENDERING TRAINING ASSESSMENTS IN SIMULATED ENVIRONMENTS

(71) Applicant: InstaTrainVR, Inc., Kennewick, WA (US)

(72) Inventors: Ashwin Joshi, Kennewick, WA (US); Amit Borkar, Indore (IN); Taran Patel, Kennewick, WA (US); Jerry Beach, Richland, WA (US)

(21) Appl. No.: 18/916,720

(22) Filed: Oct. 16, 2024

(51) Int. Cl. G06Q 50/12; G06Q 10/0639; G06T 19/00; G09B 9/00

(52) U.S. Cl. CPC G06Q 50/12; G06Q 10/06398; G06T 19/00; G09B 9/00

(57) ABSTRACT

The present disclosure providesa method and a system for rendering training assessments in simulated environments. The method is performed by a processing circuitry and includes accessing data concerning a hospitality entity, from a Hotel Operations System (HOS) application. The data is generated during a plurality of workplace scenarios. The method further includes identifying at least one workplace scenario from the accessed data. Furthermore, the method includes generating, via a Large Language Model (LLM), at least one simulated workplace scenario based, at least in part on, data concerning the at least one identified workplace scenario. Furthermore, the method includes generating at least one Virtual Reality (VR) representation based on the at least one identified workplace scenario and the at least one simulated workplace scenario. The method also includes facilitating training of an employee based on the at least one VR representation.

### TECHNICAL FIELD

The present disclosure relates to training assessments in simulated environments, and more particularly relates to methods and systems for rendering training assessments in simulated environments.

### BACKGROUND

In the hospitality industry, doing certain tasks such as managing reservation systems, collecting customer data, storing the customer and other forms of data, and analyzing the customer and the other forms of data for productivity and efficiency gains is always challenging. Currently, the hospitality industry uses various forms of software to address this problem (such as Property Management Systems (PMS) Hotel Key, and Front Office System for Select & Extended Stay (FOSSE) software used by Mariott International). Such Hotel Operations Systems (HOS) arebuilt to enhance and streamline hotel operations. They consolidate key functions like reservations, guest check-ins and check-outs, room assignments, billing, and maintenance requests into a single, easy-to-use platform. Further, integration features of such software ensure connectivity with other systems, promoting collaboration across departments.

Typically, the hospitality industry using the existing HOSfaces problems in training the employees on such complex systems. Employees have different levels of computer literacy and learning styles. Some might pick it up quickly, while others might need more time and support. Older staff members might be less familiar with technology than younger ones, requiring tailored training approaches. Dry or overly technical training materials can make it difficult for staff to stay engaged and retain information. Lack of hands-on practice can hinder employees' ability to apply what they've learned in real-world scenarios. It often takes weeks for the employees to onboard on such systems. The hospitality industry often has high turnover, meaning a constant need to train new staff on the HOS, which can be time-consuming and costly. Moreover, most of the prevalent methods of training in the hospitality industry are non-measurable.

This results in lost time and revenue for the hospitality industry or organization. Additionally, a supervisor or executive has to be assigned to train employees on such HOS resulting in a time-consuming process. Additionally, the training is usually not comprehensive, and all the potential scenarios during the hotel operations need to be considered, and solutions to address such problems must be offered.

There is a need in the hospitality industry for systems and methods for training the employees and the personnel on the HOS software, that not only reduces the training time for employees but further helps in extrapolating all the potential scenarios that can happen during the operation of a hotel and ways to address such issues to overcome the aforementioned limitations, in addition to providing other technical advantages.

### SUMMARY

According to an aspect of the present disclosure, there is provided amethod for rendering training assessments in simulated environments. The method is performed by a processing circuitry and includes accessingdata concerning a hospitality entity, from a Hotel Operations System (HOS) application. The data is generated during a plurality of workplace scenarios. The method further includes identifyingat least one workplace scenario from the accessed data. Furthermore, the method includes generating, via a Large Language Model (LLM), at least one simulated workplace scenario based, at least in part on, data concerning the at least one identified workplace scenario. Furthermore, the method includes generating at least one Virtual Reality (VR) representation based on the at least one identified workplace scenario and the at least one simulated workplace scenario. The method also includes facilitatingtraining of an employee based on the at least one VR representation.

According to another aspect of the present disclosure, there is provided a method for rendering training assessments in simulated environments. The method is performed by a processing circuitry and includes accessing data concerning a hospitality entity, from a Hotel Operations System (HOS) application. The data is generated during a plurality of workplace scenarios. The method further includes identifying at least one workplace scenario from the accessed data. Furthermore, the method includes generating, via a Large Language Model (LLM), at least one simulated workplace scenario based, at least in part on, data concerning the at least one identified workplace scenario. Furthermore, the method includes generating at least one Virtual Reality (VR) representation based on the at least one identified workplace scenario and the at least one simulated workplace scenario, and includingat least one Artificial Intelligence based Non-Player Character (AI NPC) in the at least one VR representation. The method further includes providing the at least one VR representation to the employee on a VR headset associated with the employee. The method also includes receiving employee inputs from the VR headset in response to the provision of the at least one VR representation.

According to another aspect of the present disclosure, there is provided asystem for rendering training assessments in simulated environments. The system includes a processing circuitry. The processing circuitry includes a memory unit including machine-readable instructions. Furthermore, the processing circuitry includes a processor operably connected to the memory unit. The processor is configured to execute the machine-readable instructions, the machine-readable instructions when executed by the processor, causes the processing circuitry toaccess data concerning a hospitality entity, from a Hotel Operations System (HOS) application. The data is generated during a plurality of workplace scenarios. The processing circuitry is further caused to identifyat least one workplace scenario from the accessed data. Furthermore, the processing circuitry is caused to generate, via a Large Language Model (LLM), at least one simulated workplace scenario based, at least in part on, data concerning the at least one identified workplace scenario. Furthermore, the processing circuitry is caused to generate at least one Virtual Reality (VR) representation based on the at least one identified workplace scenario and the at least one simulated workplace scenario. Also, the processing circuitry is caused to facilitate training of an employee based on the at least one VR representation.

According to another aspect of the present disclosure, there is provided asystem for rendering training assessments in simulated environments. The system includes a processing circuitry. The processing circuitry includes a memory unit including machine-readable instructions. Furthermore, the processing circuitry includes a processor operably connected to the memory unit. The processor is configured to execute the machine-readable instructions, the machine-readable instructions when executed by the processor, causes the processing circuitry to accessdata concerning a hospitality entity, from a Hotel Operations System (HOS) application. The data is generated during a plurality of workplace scenarios. The processing circuitry is further caused to identifyat least one workplace scenario from the accessed data. Furthermore, the processing circuitry is caused to generate, via a Large Language Model (LLM), at least one simulated workplace scenario based, at least in part on, data concerning the at least one identified workplace scenario. Furthermore, the processing circuitry is caused to generate at least one Virtual Reality (VR) representation based on the at least one identified workplace scenario and the at least one simulated workplace scenario, and include at least one Artificial Intelligence based Non-Player Character (AI NPC) in the at least one VR representation. The processing circuitry is further caused to provide the at least one VR representation to the employee on a VR headset associated with the employee. The processing circuitry is also caused to receive employee inputs from the VR headset in response to the provision of the at least one VR representation.

In the context of the specification, the phrase “generative AI algorithms” refers to AI-based algorithms that are capable of generating several types of content including textual content, audiovisual content, and synthetic data. Generative AI algorithms are generally trained on large amounts of data sourced through several online and offline repositories.

In the context of the specification, the phrase “Large Language Model (LLM)” refers to a type of generative AI model that is designed to perform natural language tasks like generation and comprehension. LLMs are built on machine learning and neural networks and are trained on large datasets to learn patterns and relationships between words and phrases. They can then create new text combinations that mimic natural language based on their training data. LLMs are typically trained on datasets with at least one billion parameters, which is a machine-learning term for the variables in the model that can be used to infer new content. LLMs are based on transformer-based architectures. Transformers are a deep learning architecture specifically designed for handling sequential data like text. They excel at understanding the relationships between words in a sentence and across sentences. This allows LLMs to learn the context and structure of language. Some of the well-known LLMs known in the art include GPT-3 (Generative Pre-trained Transformer 3), Jurassic-1 Jumbo, Megatron-Turing NLG (Natural Language Generation), WuDao 2.0, BLOOM (BigScience Large Open-science Open-access Multilingual Language Model), LaMDA (Language Model for Dialogue Applications), WuDao 2.0 English, Jurassic-1 GPT-J, Gemini (Google AI), etc.

In the context of the specification, the phrase “Artificial Intelligence based Non-Player Character (AI NPC)” refers to a character in a virtual world that is controlled by Artificial Intelligence (AI) algorithms instead of a human player. TheAI NPCs are designed to interact with players and their environment in a more dynamic, believable, and engaging way than traditional NPCs. AI NPCs can exhibit complex behaviors like adaptive decision-making (adjusting their actions based on player choices and the changing circumstances in the virtual world), learning and evolving (remembering past interactions and modifying their behavior over time), emotional responses (expressing emotions and reacting to the player's emotional stat), and Natural Language Processing (engaging in more realistic and dynamic conversations). The AI NPCs may be generated by combining digital entities such asvisual 3-Dimensional (3D) avatars, voice-based assistants, and chatbots utilizing text-based messaging in several different possible combinations. For example, an AI NPC may either be a 3D avatar, a voice-based assistant, or a chatbot. Alternately, an AI NPC may be a combination of two different types of entities, such as a combination of a 3D avatar and a voice-based assistant, or a combination of a voice-based assistant and a chatbot. Alternately, an AI NPC may have all three capabilities, such as a combination of a 3D avatar, a voice-based assistant, and a chatbot. Many such combinations are possible as would be appreciated by a person skilled in the art.

### BRIEF DESCRIPTION OF THE FIGURES

For a more complete understanding of example embodiments of the present technology, reference is now made to the following descriptions taken in connection with the accompanying drawings:

FIG. 1 illustrates a schematic representation of an environment in which at least some of the embodiments of the present disclosure may be implemented;

FIG. 2 illustrates a logical block diagram of a processing circuitry and a storage device, in accordance with an embodiment of the present disclosure;

FIG. 3 illustrates a schematic depicting accessing of data concerning a hospitality entity, in accordance with an embodiment of the present disclosure;

FIG. 4A illustrates a schematic depicting identification of at least one workplace scenario from the accessed data, in accordance with an embodiment of the present disclosure;

FIG. 4B illustrates a schematic depicting generation of at least one simulated workplace scenario, in accordance with an embodiment of the present disclosure;

FIG. 5A illustrates a schematic depicting generation of at least one Virtual Reality (VR) representation based on the at least one identified workplace scenario and the at least one simulated workplace scenario, in accordance with an embodiment of the present disclosure;

FIG. 5B illustrates the at least one generated VR representation provided to a VR headset, in accordance with an embodiment of the present disclosure;

FIG. 5C illustrates an example VR representation including a questionnaire-based test provided to the VR headset, in accordance with another embodiment of the present disclosure;

FIG. 6 illustrates a block diagram depicting generation of an assessment report, in accordance with an embodiment of the present disclosure; and

FIG. 7 illustrates a flow diagram depicting a method for rendering training assessment in simulated environments, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

Various example embodiments of the present disclosure provide methods and systems for rendering training assessments in simulated environments. Data concerning the hospitality entity is accessed from a Hotel Operations System (HOS) application. The data concerning the hospitality entity is envisaged to be generated during a plurality of workplace scenarios. In several embodiments, the data is accessedin the form of several screenshots of a User-Interface (UI) of the HOS application. In that regard, the data may be accessed from several employee client devices connected to the HOS application and running one or more front-end applications associated with the HOS application. In several alternate embodiments, the data is accessed from an HOS application server hosting the HOS application in the form of video files, audio files, text data, spreadsheets, etc. The accessed data may be further analyzed to extract information at least in the form of text-based interactions, numerical data, and time-stamped events. Furthermore, the text-based interactions, the numerical data, and the time-stamped events may be utilized to identify at least one workplace scenario associated with the hospitality entity. Furthermore, based on the at least one identified workplace scenario, at least one simulated workplace scenario may be generated using a Large Language Model (LLM). In that regard, in addition to the text-based interactions, the numerical data, and the time-stamped events, the LLM may be provided with predetermined characteristics of the at least one simulated workplace scenario. For example, the predetermined characteristics may include a type, criticality, expected skill level in handling the simulated scenario, duration, starting time instant, ending time instant, a number of unexpected events, and so on.

Furthermore, a Virtual Reality (VR) representation may be generated based on the at least one identified workplace scenario and the at least one simulated workplace scenario. The VR representation may be used to facilitate the training of an employee of the hospitality entitythrough a VR headset. The VR representation may further be provided with interface elements such as menus, tabs, buttons, windows, prompts, scores, and suggestionsduring the training. Furthermore, an Artificial Intelligence based Non-Player Character (AI NPC) mimicking either a guest or a fellow employee (such as a supervisor) may be included in the VR representation. In that regard, the AI NPC may be configured to exhibit dynamic behavior and possess abilities such as Natural Language Processing (NLP). Employee inputs in the form of messages, interactions with the interface elements, and responses to questions may be collected during a training session. In several non-binding embodiments, employee biometric data received through one or more biometric sensors (such as a temperature sensor, a heartrate sensor, a microphone, a camera, etc.) may also be collected during the training session in addition to the employee inputs.

An assessment report may be generated based on employee inputs and (optionally) on the employee biometric data. The assessment report may include quantitative scores, qualitative observations, and visualizations to underscore key findings. The assessment report may be exported by the employee in several available formats and be used by the employee to apply for job confirmation, promotions, and future career opportunities. Also, the employee inputs and the assessment reports may be stored to improve existing training modules, generate new training modules, and recommend changes in policies and operating procedures of the hospitality entity.

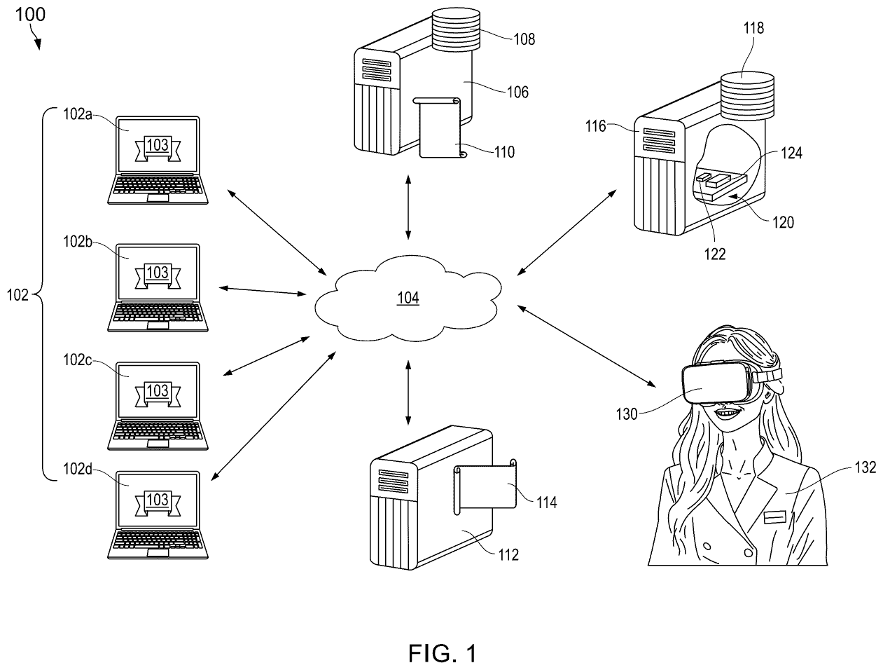

Various example embodiments of the present disclosure are described hereinafter with reference to FIG. 1 to FIG. 7.

FIG. 1 illustrates a schematic representation of an environment 100 in which at least some of the embodiments of the present disclosure may be implemented. The environment 100 includes a plurality of employee client devices 102 (For example, 102a, 102b, 102c, and 102d) associated with a plurality of employees of a hospitality entity. The hospitality entity in that regard may be a hotel, a resort, a hostel, a restaurant, a café, a bar, a nightclub, and the like. The plurality of employee client devices 102 may be selected from a group consisting of Personal Computers (PCs), tablet devices, Personal Digital Assistants (PDAs), voice-activated assistants, Virtual Reality (VR) devices, smartphones, and laptops. The plurality of employee client devices 102 are connected to a communication network 104 and have access to a Hotel Operations System (HOS) application 110 hosted by an HOS Application server 106.

The communication network 104 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication between any two entities/devices illustrated in FIG. 1. Furthermore, various entities in the environment 100 may connect to the communication network 104 following various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, New Radio (NR) communication protocol, any future communication protocol, or any combination thereof. In some instances, the communication network 104 may utilize a secure protocol (e.g., Hypertext Transfer Protocol (HTTP), Secure Socket Lock (SSL), and/or any other protocol, or set of protocols for communicating with the various entities depicted in FIG. 1.

The HOS application 110 may be a suite of one or more applications selected from a group consisting of, but not limited to:
1. Front office management:
   i. Reservation management: handles bookings from various channels (online, phone, walk-in), manages room availability, and tracks guest preferences;
   ii. Guest check-in/check-out: automates the check-in and check-out process, including ID verification, payment processing, and key card issuance;
   iii. Concierge services: manages guest requests, such as booking tours, arranging transportation, and providing information about local attractions;
   iv. Housekeeping management: tracks room status (clean, dirty, occupied), assigns cleaning tasks to staff, and manages inventory of cleaning supplies,
2. Back-office management:
   i. Accounting and finance: handles billing, invoicing, payment processing, and financial reporting:
   ii. Human resources management: manages employee information, payroll, scheduling, and performance reviews;
   iii. Inventory management: tracks stock levels of hotel supplies, such as toiletries, linens, and mini-bar items;
   iv. Maintenance management: logs and tracks maintenance requests, schedules repairs, and manages preventative maintenance tasks,
3. Revenue management:
   i. Rate management: optimizes room rates based on demand, seasonality, and competitor pricing;
   ii. Yield management: maximizes revenue by analyzing booking patterns and adjusting inventory availability;
   iii. Channel management: distributes room availability and rates across various online travel agents (OTAs) and booking platforms,
4. Guest Relationship Management:
   i. Guest profiles: stores guest data, preferences, and stay history to personalize service and marketing efforts;
   ii. Loyalty management: manages loyalty programs to reward repeat guests and encourage future bookings;
   iii. Guest communication: facilitates communication with guests before, during, and after their stay,
5. Point-of-Sale (POS):
   i. Restaurant and bar management: processes orders, manages inventory, and tracks sales for hotel restaurants and bars;
   ii. Gift shop and retail: manages sales transactions for any retail outlets within the hotel,
6. Reporting and analytics:
   i. Performance dashboards: provides real-time insights into key performance indicators (KPIs), such as occupancy rates, revenue per available room (RevPAR), and guest satisfaction scores;
   ii. Custom reports: generates customized reports to analyze specific aspects of hotel operations,
7. Integrations:
   i. Channel manager: connects with online travel agents (OTAs) to distribute inventory and manage rates;
   ii. Revenue management system: integrates with revenue management tools to optimize pricing and inventory;
   iii. Payment gateway: integrates with payment processors to facilitate secure online payments.

The plurality of employees of the hospitality entity may be able to access the HOS application 110 through one or more front-end applications 103 installed on the plurality of respectiveemployee client devices 102. For example, depending upon aspects such as location, designation, roles and responsibilities, etc. the architecture and general make-up of the one or more front-end applications 103 may vary amongst the plurality of employee client devices 102. In that regard, each one of the one or more front-end applications 103 may include elements such as visual design, user experience (UX), interactivity, interface elements (such as menus, buttons, links, etc.), and content (such as text, images, videos, and other visual information such as icons, etc.).

Furthermore, the HOS application server 106 receives data concerning the hospitality entity from the one or more front-end applications 103 and other connected devices (such as Closed CircuitTelevision (CCTV) cameras, telephone lines, social media applications, messaging services, e-mail servers, biometric sensors, etc.) and stores the data in an HOS storage device 108 associated with the HOS application server 106. The HOS storage device 108 may be a non-volatile memory type storage device and may be selected from a group consisting of Solid-State Drives (SSDs), Hard Disk Drives (HDD), flash memory, Non-Volatile Memory Express (NVMe), cloud storage gateways, and the like. In several alternate embodiments, the HOS storage device 108 may be a Network Attached Storage (NAS), a Storage Area Network SAN), or a distributed storage system. The data concerning the hospitality entity is envisaged to be generated during a plurality of workplace scenarios.

Some non-limiting examples of the plurality of workplace scenarios include:
1. Front-of-house scenarios (such as managing reservations, answering inquiries, handling check-ins/check-outs, arranging transportation, booking tours and activities, resolving guest issues, serving food and beverages);
2. Back-of-house scenarios (such as maintaining guest rooms and public areas, cleaning and sanitizing dishes, utensils, and kitchen equipment, performing repairs and maintenance on the building and its systems, ensuring everything is in working order);
3. Management scenarios (such as ensuring guest satisfaction, managing staff, maximizing profitability, managing restaurant operations, overseeing staff, ensuring customer satisfaction, and controlling costs, hiring, and training staff, managing employee relations, ensuring compliance with labor laws); and
4. Other scenarios (such as organizing and coordinating events such as conferences, weddings, and parties, promoting the hotel or restaurant, attracting new customers, and developing marketing strategies).

Furthermore, the data stored in the HOS storage device 108 may be stored as video files, audio files, text data, images, spreadsheets, etc. For example, HOS storage device 108 may store structured data such as guest information, reservation details, room inventory, and financial transactions in SQL databases, comma-separated value (CSV) files, spreadsheets, etc. Guest reviews, feedback forms, internal memos, and other textual information might be stored as plain text files or in formats like DOCX or PDF. Photos of guests (for identification purposes), scanned documents (like passports), and images of hotel rooms or facilities might be stored in formats like JPEG, PNG, or GIF. Security camera footage, promotional videos, or recordings of events might be stored in formats like MP4 or AVI. System logs, application data, and other system-specific information might be stored in binary format. Some HOS applications might use their own proprietary formats for storing specific types of data. Semi-structured data may also be stored as JSON (JavaScript Object Notation) or XML (Extensible Markup Language) objects.

Furthermore, an LLM server112 hosting an LLM 114 is connected to the communication network 104.The LLM 114 may be available to any device connected to the communication network 104 through respective Application Program Interface (API) calls to the LLM server 112. In several embodiments, the LLM server 112 may be an in-house server associated with the hospitality entity and may be implemented on a physical machine, a virtual machine, or a containerized service. In several embodiments, the LLM server 112 may be a third-party server, such as a cloud-based server available on a subscription basis. Furthermore, a Virtual Reality (VR) headset 130 is connected to the communication network 104 for training an employee 132 who may be a new employee or an old employee being trained on new procedures, or being given a refresher course. In several embodiments, the VR headset 130 may also include built-in microphones and cameras (not shown) for recording aural and gestural inputs of the employee 132. In several alternate embodiments, where the VR headset 130 may be lacking microphones and/or cameras, auxiliary cameras and/or auxiliary microphones may be attached to the VR headset 130 for enabling recording of the aural and the gestural inputs. Alternately, the auxiliary cameras and the auxiliary microphones may be provided in a facility such as a room where the employee 132 is intended to be trained. In several embodiments, although not bindingly, one or more biometric sensors (not shown) such as temperature sensor, heartrate sensor, etc. associated with the employee 132 may also be connected to the communication network 104 for monitoring employee biometric data associated with the employee 132. The employee biometric data may also be collected by analyzing the speech and gestural inputs of the employee 132.

Also connected to the communication network 104is a system116. The system116 is configured to manage a training application that is envisaged to automatically generate at least parts of training modules used to train both new and existing employees of the hospitality entity. In that regard, the system116 is envisaged to include hardware capabilities such as processing circuitry120.The processing circuitry120 is envisaged to include a processor 122 and a memory unit 124. The processor 122 may be selected from a group consisting of a microcontroller, a general-purpose processor, a System on Chip (SoC), a Field Programmable Gate Array (FPGA), an Application Specific Integrated Circuit (ASIC), and the like. The memory unit 124may be selected from a group consisting of volatile memory units such as, but not limited to, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc. Further, coupled with the system116 is a storage device 118. The storage device 118 may be a non-volatile memory type storage device and may be selected from a group consisting of Solid-State Drives (SSDs), Hard Disk Drives (HDD), flash memory, Non-Volatile Memory Express (NVMe), cloud storage gateways, and the like. In several alternate embodiments, the storage device 118 may be a Network Attached Storage (NAS), a Storage Area Network SAN), or a distributed storage system. In several embodiments, the system116 may be an in-house server associated with the hospitality entity and may be implemented on a physical machine, a virtual machine, or a containerized service. In several embodiments, the LLM server 112 may be a third-party server, such as a cloud-based server available on a subscription basis.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. In addition, the system116 should be understood to be embodied in at least one computing device in communication with the communication network 104, which may be specifically configured, via executable instructions, to perform steps as described herein, and/or embodied in at least one non-transitory computer-readable media.

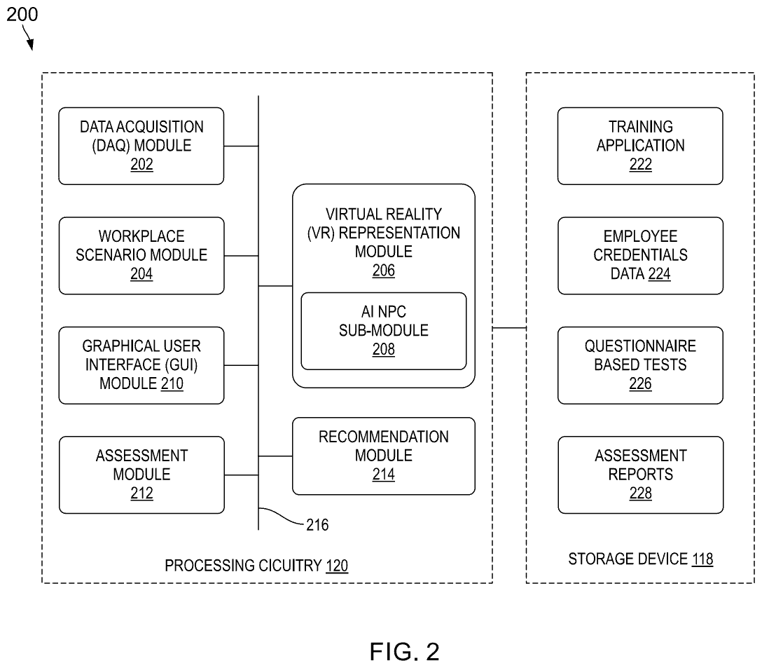

FIG. 2 illustrates a logical block diagram 200 of theprocessing circuitry120 and the storage device 118, in accordance with an embodiment of the present disclosure. The processing circuitry120 has been depicted to include several modules including anDataAcquisition (DAQ) module202, a workplace scenario module 204, a Virtual Reality (VR) representation module206, a Graphical User Interface (GUI) module210, an assessment module212, and a recommendation module214. Furthermore, the VR representation module 206 includes an Artificial Intelligence based Non-Player Character (AI NPC) sub-module 208. The several modules of the processing circuitry120 are configured to communicate with each other through a communication bus 216 using predefined protocols. The DAQ module202, the workplace scenario module 204, the VR representation module206, the AI NPC sub-module 208, the GUI module210, the assessment module212, the recommendation module214,and the communication bus 216may be implemented through combinations of machine-readable instructions stored in the storage device 118 and hardware elements of the processor 122.

During runtime, the machine-readable instructions stored in the storage device 118 may be loaded into the memory unit 124and executed by the processor 122 to enable the implementation of the several modules listed above and the communication bus 216. In alternate implementations, the machine-readable instructions for implementing the several modules and the communication bus 216 may be permanently stored in the processing circuitry120 through a non-volatile memory device such as an EPROM unit, an EEPROM unit, a flash memory unit, and the like. A person skilled in the art would appreciate that alternate implementations of the processing circuitry 120 with modules being given alternate or different names or combined or divided to render a different number of modules are within the scope of the disclosure as long as they perform similar functions as will be described in the following discussion.

Furthermore, the storage device 118 is configured to store several databases and programs, logic written in programming languages such as C, C++, Java, Python, etc. The stored databases may be, for example, but are not limited to, relational databases, vector databases, and graph databases provided along with respective database management systems to provide read and write access to the stored databases. In an example embodiment, the storage device 118 includes a training application 222configured to store machine-readable instructions for generating several training modules for the training of new and existing employees of the hospitality entity.

The training modules may correspond to:
1. Onboarding and orientation (for example introduction to mission, vision, and values, overview of organizational policies, code of conduct, dress code, safety regulations, understanding of roles and responsibilities, clarification of job duties, performance standards, and reporting structures);
2. Job-specific training (for example training on specific tools and technologies used in the role, such as Point of Sale (POS) systems, or reservation software, learning how to perform tasks related to the specific job, such as check-in/check-out procedures for front desk staff, food and beverage service for restaurant staff, or housekeeping procedures for room attendants, familiarization with the products and services offered by the hospitality entity, including room types, amenities, dining options, and local attractions);
3. Customer service training (for example, developing effective communication skills, including verbal, nonverbal, and written communication, building rapport with guests, handling complaints, and resolving conflicts, understanding and respecting diverse cultures and customs, learning proper guest interaction protocols and service standards);
4. Safety and security training (training on how to handle emergencies such as fires, medical situations, and security threats, basic life support, and first aid training, understanding security procedures, including guest identification, key control, and access control, Proper food handling and sanitation procedures (especially for food and beverage staff)); and
5. Soft skills training (developing collaboration and communication skills within a team environment, enhancing critical thinking and decision-making skills, prioritizing tasks and managing time effectively, developing coping mechanisms for handling stressful situations).

In several embodiments, the training modules may be implemented with the processor 122 executing the machine-readable instructions stored in the training application 222 and loaded into the memory unit 124 during run-time. In that regard, in such embodiments, the logical diagram of the processing circuitry 120 as depicted in FIG. 2 may correspond to a runtime implementation of the processing circuitry 120.

Furthermore, the storage device 118 may include employee credentials data 224. The employee credentials data 224 may include names of employees, employment information (such as employee ID, designation, clearance level, location, etc.), usernames, passwords, current proficiency levels, and the like. The employee credentials data 224 may be used by the processing circuitry120to validate the identity of the employee 132during a training session. The storage device 118 may further include several questionnaire-based tests 226 that would be presented to the employee 132 during the training sessions along with VR representations of simulated scenarios as will be discussed in the following discussion. The storage device 118may also store a plurality of assessment reports 228 generated during several respective training sessions of the employees of the hospitality entity to track their progress over time, modify the existing training modules, generate new training modules, etc. The processing circuitry120 may communicate with the storage device 118 through a storage interface such as an Advanced Technology Attachment (ATA) adapter, a Serial ATA (SATA) adapter, a Small Computer System Interface (SCSI) adapter, a redundant array of independent disks (RAID) processing circuitry, a Storage Area Network (SAN) adapter, a network adapter, and/or any component providing the processing circuitry120 access to the storage device 118.

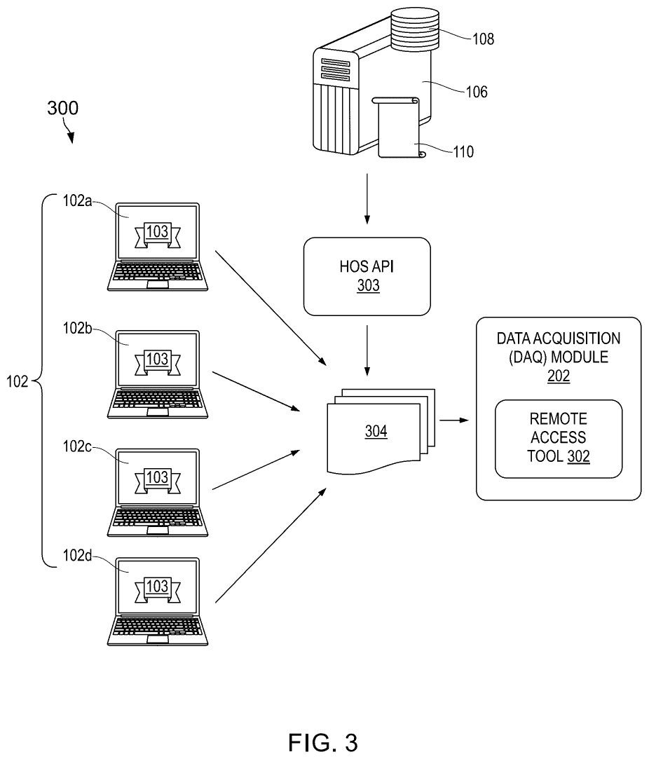

FIG. 3 illustrates a schematic 300 depicting accessing of data 304 concerning the hospitality entity, in accordance with an embodiment of the present disclosure. In that regard, the DAQ module 202 may deploy a remote access tool 302to access the plurality of employee client devices 102 running the one or more front-end applications 103. In several embodiments, the DAQ module 202 may access the data 304 concerning the hospitality entity in the form of a plurality of screenshots of a user interface (UI) of the HOS application 110 generated by each one of the one or more front-end applications 103. Furthermore, the DAQ module 202 may deploy code written in a scripting language such as Python or PowerShell to automate the screenshot capture process. The scripts may be written to connect to the plurality of employee client device 102 through the remote access tool 302, capture the plurality of screenshots at specific intervals or based on triggers (such as a new data entry event), and save the plurality of screenshots in a designated folder with information such as timestamps and geographical location tags. For example, the plurality of screenshots may be stored in the storage device 118.

In several embodiments, alternately or in addition to the plurality of screenshots, the DAQ module 202 will access the data 304 from the HOS storage device 108, by connecting to the HOS application server 106 using API calls made to an HOSAPI 303. In that regard, the accessed data 304 may also include video files, audio files, text data, spreadsheets, etc. For example, the accessed data 304 may include structured data such as guest information, reservation details, room inventory, and financial transactions stored in the form of SQL databases, comma-separated value (CSV) files, spreadsheets, etc. Furthermore, the accessed data 304 may include guest reviews, feedback forms, internal memos, and other textual information stored as plain text files or in formats like DOCX or PDF. The accessed data 304 may further include photos of guests (for identification purposes), scanned documents (like passports), and images of hotel rooms or facilities stored in formats like JPEG, PNG, or GIF. The accessed data 304 may further include security camera footage, promotional videos, or recordings of events stored in formats like MP4 or AVI. Furthermore, the accessed data 304 may include system logs, application data, and other system-specific information that might be stored in binary format or any other proprietary format. The accessed data 304 may also include semi-structured data stored as JSON (JavaScript Object Notation) or XML (Extensible Markup Language) objects.

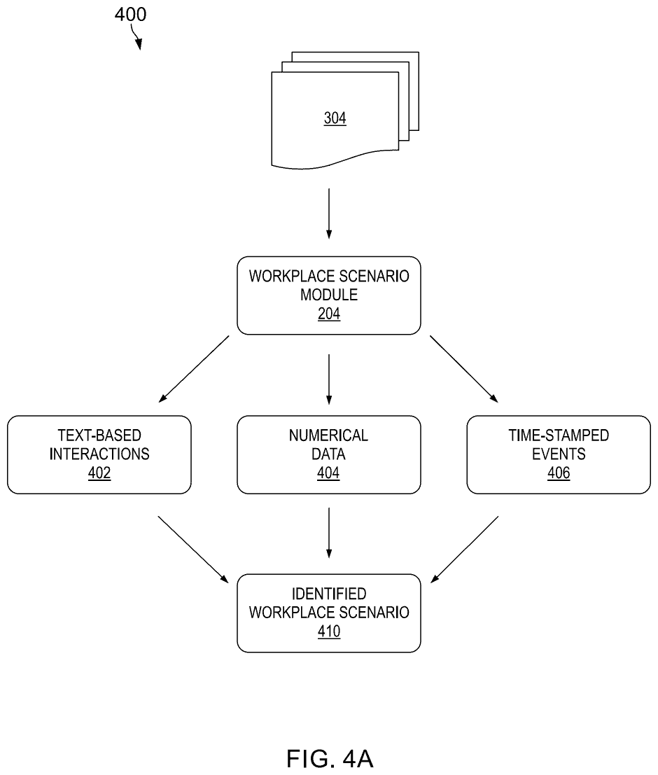

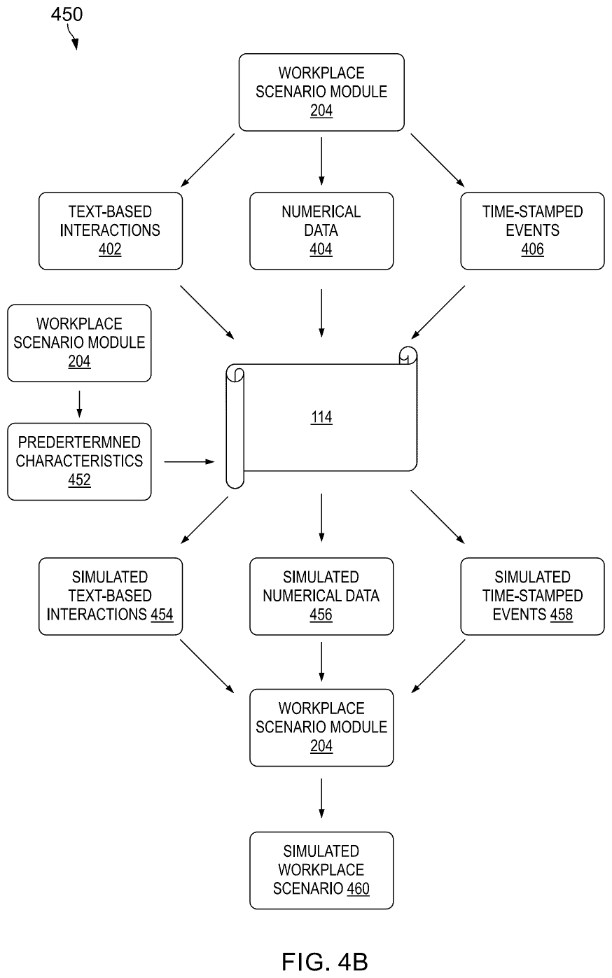

FIG. 4A illustrates a schematic 400 depicting identification of at least one workplace scenario 410 from the accessed data, in accordance with an embodiment of the present disclosure. In several embodiments, the workplace scenario module 204extracts different kinds of information from the accessed data304. In a non-limiting example, the workplace scenario module 204 may extracttext-based interactions 402 amongst the employees and between the employees and the guests. For example, the text-based interactions 402 may include guest profiles including names, contact details, addresses, preferences, special requests, and communication logs i.e. records of interactions with guests, including emails, SMS messages, chat conversations, and notes from phone calls. This can include booking confirmations, pre-arrival messages, requests for services, and feedback. The text-based interactions 402may also include text-based feedback collected through online surveys or review platforms, guest comments and mentions on social media platforms, messages and notes exchanged between the employees, logs of automated email or SMS campaigns sent to guests, etc. The text-based interactions 402 may also include records of any incidents or complaints, including details of the issue, resolution steps taken, and guest satisfaction feedback, logs of any special requests made by guests, such as extra towels, room service, or maintenance requests.

Furthermore, the extracted information may include numerical data404. The numerical data 404may include guest and room-related data such as the number of guests per reservation, occupancy per room, total guests in the hotels, number of nights stayed by each guest or reservation, age, number of children, and other relevant demographic data, unique identifiers for each room in the hotel, price per night for different room types and occupancy levels, percentage of occupied rooms over a specific period, number of available rooms for a given date range. The numerical data 404 may also include performance metrics such as KPIs, guest satisfaction scores, and occupancy percentages, and financial data such as revenues, costs, profit margins, taxes, and fees. In addition, the numerical data 404 may include website traffic, booking channel data, loyalty program data, and event attendance. The informationextracted by the workplace scenario module 204 may also include time-stamped events 406. For, the time-stamped events 406 may includereservation creation, guest check-ins and check-outs, orders, requests, complaints, staff logins and logouts, task assignments and completions, maintenance logs, complete repairs, inventory updates, room status changes, system access, software updates, error logs, payments, refunds, etc.

The workplace scenario module 204 may combine the text-based interactions 402, the numerical data 404, and the time-stamped events 406 to identify the at least one workplace scenario 410 from the accessed data 304. In several embodiments, the workplace scenario module 204 identifies at least one feature indicative of the at least one identified workplace scenario 410. For example, the at least one feature includes at least one of a type of the at least one identified workplace scenario 410, a duration of the at least one identified workplace scenario 410, and an outcome of the at least one identified workplace scenario 410.For example, an identified (type: billing issue) workplace scenario may have started at the time of checkingout (for example, at 12:00 PM) and ended at 12:20 PM and therefore would have lasted 20 minutes. The outcome of the identified workplace scenario would have been a guest giving positive feedback for the successful resolution of a billing issue. Furthermore, identification of the at least one identified workplace scenario 410 may include identification of normal workplace scenarios such as room allocation, booking of a cab, fixing a complaint, cleaning the room, generating annual financial reports, performance of periodic audits, and upgradation of facilities. The identification of the at least one identified workplace scenario 410 may also include the identification of critical workplace scenarios such as scenarios concerning human trafficking, sexual misconduct, diversity and inclusion, mental health and well-being, workplace safety and security, ethical conduct and compliance, and customer service excellence.

FIG. 4B illustrates a schematic 450 depicting generation of at least one simulated workplace scenario460, in accordance with an embodiment of the present disclosure. In that regard, the workplace scenario module 204 leverages the LLM 114 to generate the at least one simulated workplace scenario 452 based at least in part on the data concerning the at least one identified workplace scenario 410. For example, the workplace scenario module 204 may use the text-based interactions 402, the numerical data 404, the time-stamped events 406, and predetermined characteristics 452 of the at least one simulated workplace scenario 460 in prompting the LLM 114. The generation of the at least one simulated workplace scenario 452 using the LLM 114 may include steps such as the conversion of the data into text-based prompts, anonymization, prompt generation (such as the definition of desired characteristics, output format), prompt feeding to generate outputs, and fine-tuning using prompt-engineering. The LLM 114 may then generate simulated text-based interactions 454, simulated numerical data 456, and simulated time-stamped events 458 which may then be used by the workplace scenario module 204 to generate the at least one simulated workplace scenario 460.

The at least one simulated workplace scenario 460 may be a normal workplace scenario such as room allocation, booking of a cab, fixing a complaint, cleaning the room, generating annual financial reports, performance of periodic audits, upgradation of facilities, etc. Alternately, the at least one simulated workplace scenario460may be a critical workplace scenario. For example, a simulated workplace scenario concerning human trafficking would train the employee 132to recognize signs of human trafficking and procedures for responding and reporting. Similarly, a simulated workplace scenario concerning sexual misconduct would train the employee 132 to identify different forms of sexual harassment and assault and support the victims appropriately. A simulated workplace scenario concerning diversity and inclusion would train the employee 132 to recognize and mitigate bias and create an inclusive workplace environment.

A simulated workplace scenario concerning mental health and well-being would train the employee 132 to access mental health resources and support systems and handle mental health crises in the workplace. A simulated workplace scenario concerning workplace safety and security would train the employee 132 to respond to workplace emergencies ensuring secure environments for both the personnel and the guests. A simulated workplace scenario concerning ethical conduct and compliance would train the employee 132 to follow ethical guidelines, local laws, and regulations and eliminate unethical behavior and corrupt practices. A simulated workplace scenario concerning customer service excellence would train the employee 132 on communication skills, conflict resolution, and best practices for delivering exceptional customer services.

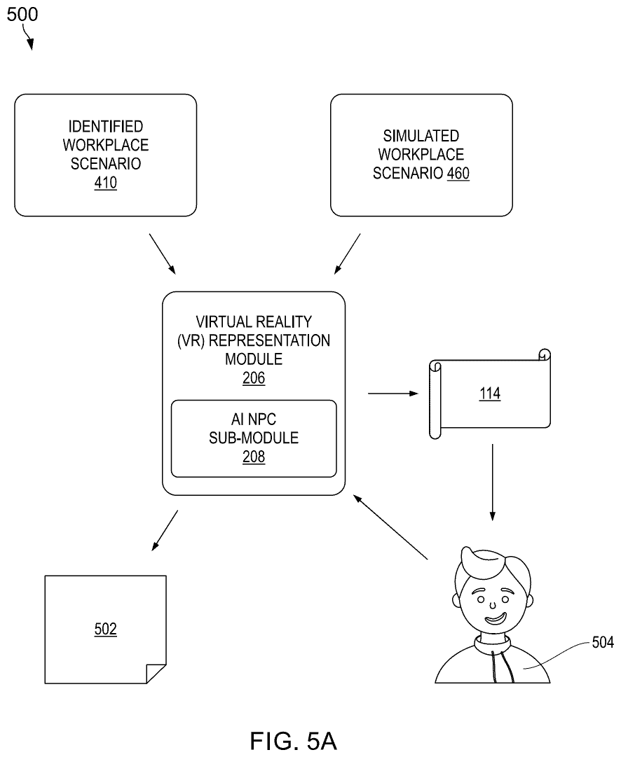

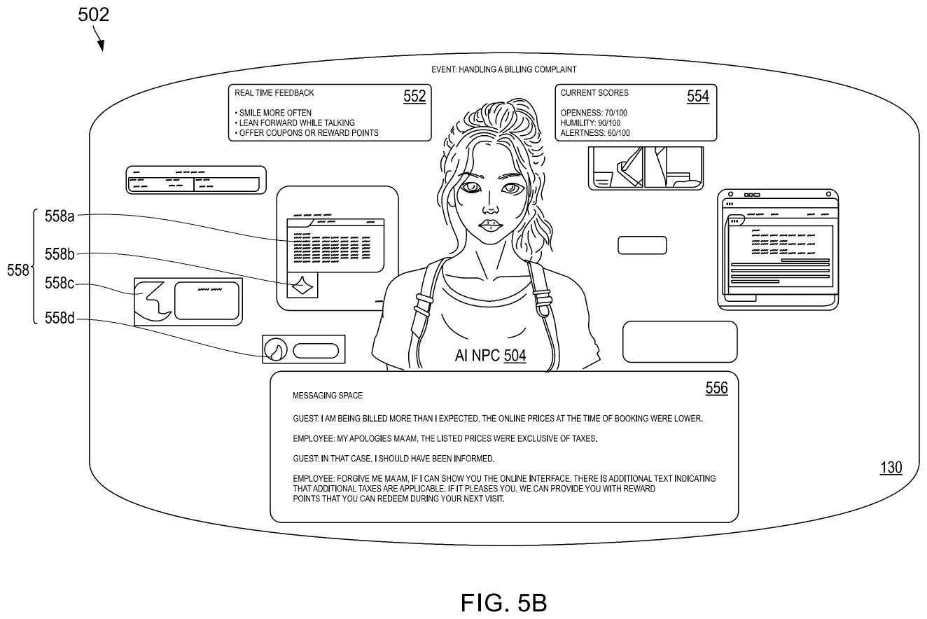

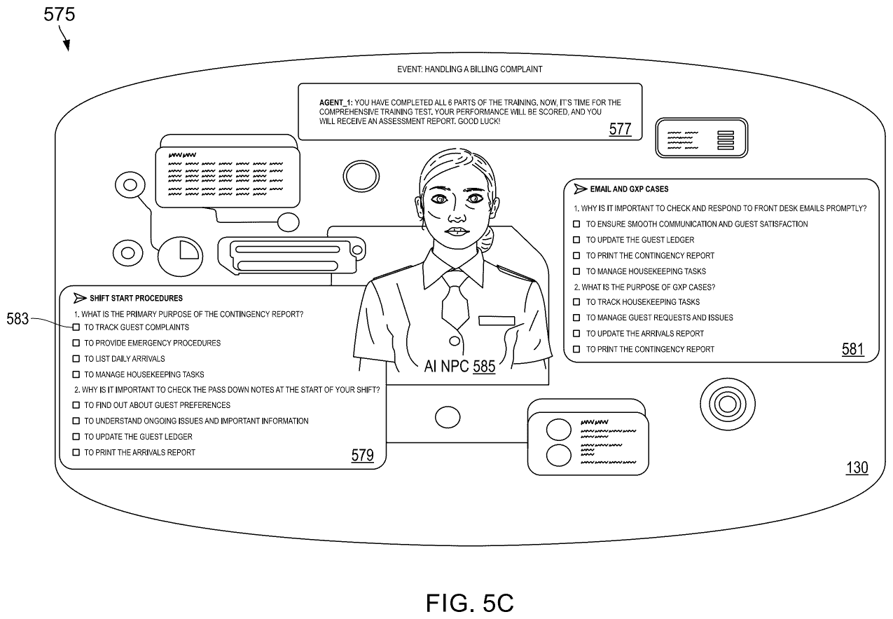

FIG. 5A illustrates a schematic 500 depicting generation of at least one VR representation 502 based on the at least one identified workplace scenario 410 and the at least one simulated workplace scenario460, in accordance with an embodiment of the present disclosure. The at least one VR representation 502 may be generated by the VR representation module 206 based on the at least one identified workplace scenario 410 and the at least one simulated workplace scenario 460. In that regard, the at least one VR representation 502 may pertain to several possible workplace scenarios such as guest arrivals and departures, service requests, complaints and resolution, employee scheduling and shifts, meetings and reviews, incident reporting, housekeeping and room cleaning, maintenance and repair, inventory management, security and safety procedures, payment processing, revenue management, financial reporting, promotional campaigns, social events such as weddings, conferences, and meetings, etc.

Furthermore, in several embodiments, the AI NPC sub-module 208 also generates at least one AI NPC 504to be included in the VR representation 502. The at least one AI NPC 504 may be generated based on the text-based interactions 402extracted by the workplace scenario module 204. In several embodiments, the at least one AI NPC 504 would have a dynamic behavior and would be configured to simulate real-life professional responses dynamically in evolving VR representations based on responses provided by the employee132. In that regard, the at least one AI NPC 504 may be enabled by the LLM 114 to haveNatural Language Processing (NLP) capabilities allowing them to engage in conversation with the employee132.Furthermore, the at least one AI NPC 504 may be configured to have access to past interactions with the employee132 providing a more personalized challenge to the employee132. Also, the at least one AI NPC 504 may be configured to exhibit emergent behavior, where unexpected and unscripted scenarios arise from the interactions between the employee132 and the at least one AI NPC 504. The GUI module210 may be configured to render the VR representation 502 and the at least one AI NPC 504on the VR headset130, once the VR representation 502 and the at least one AI NPC 504 have been generated.

FIG. 5B illustrates the generated at least one VR representation502provided to theVR headset130, in accordance with an embodiment of the present disclosure. The at least one VR representation 502is a VR representation of a simulated workplace scenario concerning handling a billing complaint. The at least one VR representation 502 includes a real-time feedback window 552 that provides feedback and suggestions to the employee132 in real-time during the training session. The real-time feedback window 552 in this case would mimic a supervisor eliminating the need for a supervisor to be present in person. Furthermore, the at least one VR representation 502 includes a current scores window 554that provides current scores over several parameters such as openness, humility, alertness, etc. enabling the employee132 to adjust their behavior and mental state in real-time thereby simulating real-life conditions. The scores in the current scores window 554 may be generated based on responses provided by the employee132 in a messaging space window 556. Although the responses in the messaging space window 556 appear in textual format, they may be provided by the employee 132 by speaking through a built-in microphone or selecting an interface element using a hand gesture captured by a built-in camera. The scores may also be adjusted based on the employeebiometric data gathered from the one or more biometric sensors such as the temperature sensor, the heartrate sensor, the microphones, and the cameras.

The at least one AI NPC 504 is also included in the at least one VR representation 502 provided to the VR headset130. The at least one AI NPC 504 is configured to mimic responses, gestures, body language, facial expressions, etc. of a real-life guest. The at least one VR representation 502 may also include prompts for specified tasks such as printing an invoice, handing over keys to a valet service executive, closing a plumbing valve, sending out instructions to housekeeping staff, and the like. In several embodiments, the GUI module210 may also render additional interface elements 558 (for example, 558a, 558b, 558c, 558d) (such as buttons, radio buttons, checkboxes, dropdown menus, sliders, tabs, cards, lists, etc.) in the at least one VR representation 502 to enable, for example, selection of training modules, responding to prompts, minimizing and maximizing windows, playing, pausing and exiting training sessions, a running analog or digital clock for timekeeping, and the like. In addition to the at least one VR representation 502, the employee 132 may also be assessed through the questionnaire-based tests 226 provided in an additional example VR representation discussed below.

FIG. 5C illustrates an example VR representation 575 including a questionnaire-based test(or “the test”) provided to the VR headset 130, in accordance with another embodiment of the present disclosure. The example VR representation 575 may be provided to the VR headset 130 either in alternate or in addition to and following the at least one VR representation 502. The example VR representation 575has been divided into several modules. A first module577includes a welcome message by an AI NPC585 (Agent_1). The AI NPC 585 is configured to mimic responses, gestures, body language, facial expressions, etc. of a real-life trainer or a supervisor. In several embodiments, the first module577 may also include rules for the test 575, such as a number of topics covered, a number of questions for each topic, points carried by each question, and the like. A second module579 includes questions concerning a first topic, for example, shift start procedures. Also, a third module581 includes questions concerning a second topic, for example, email and GXP cases. For each possible answer to a question, there has been provided a checkbox 583as an interface element. The example VR representation 575 may include many such additional modules and topics having any number of questions without departing from the scope of the present disclosure. Furthermore, in several embodiments, the test may apply negative-marking-based scoring. However, in several alternate embodiments, the test may not apply negative-marking-based scoring.

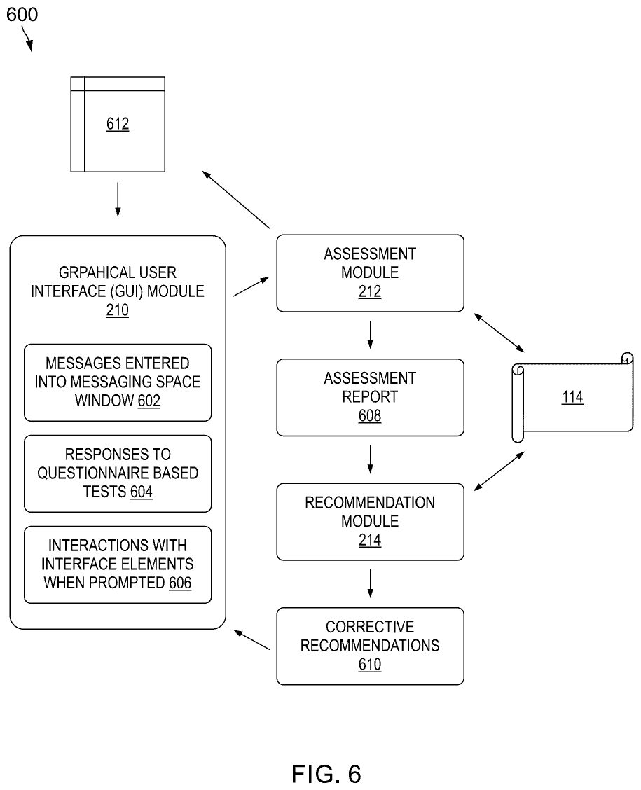

FIG. 6 illustrates a block diagram 600depicting generation of an assessment report608, in accordance with an embodiment of the present disclosure. The assessment module212 is configured to generate the assessment report 608 by taking in and processing several employeeinputs provided by the employee 132 through the VR headset 130. In several embodiments, although not bindingly, the assessment module 212 may also factor in the employee biometric data during the generation of the assessment report 608. The employee biometric data may be provided to the assessment module212 by the one or moreemployee biometric sensors (for example, the temperature sensor, the heartrate sensor, the built-in microphones, and the built-in cameras). Furthermore, the assessment module212 may receive messages602entered in the messaging space window 556 from the GUI module210 as the employee inputs. In several embodiments, the GUI module210 also provides to the assessment module212, responses 604 to the test 575, and interactions 606 of the employee 132 with the interface elements 558 in the VR representation 502 and the test 575. The responses 604 may be provided as aural inputs through the built-in or auxiliarymicrophones or as gestural inputs through the built-in or auxiliarycameras. The interactions 606 may be provided as gestural inputs through the built-in or auxiliary cameras. The responses 604 and the interactions 606 would also be regarded as the employee inputs. The assessment module212 may then communicate with the LLM 114to generate the assessment report 608 based on the employee biometric data (optional), the messages 602, the responses 604, and the interactions606.

For example, the LLM 114 can analyze text for sentiment, key themes, language complexity, and coherence. Techniques like natural language processing (NLP) can extract relevant features and convert text into numerical representations. Physiological data like heart rate, temperature, and skin conductance can be processed to extract features like variability, average levels, and responsiveness to stimuli. Eye-tracking data can reveal attention patterns, focus, and areas of interest. Gestures can be categorized and quantified. Interactions with interface elements 558 like buttons, menus, and text fields can be recorded and analyzed for patterns, hesitations, and efficiency of navigation. This data can reveal problem-solving approaches, decision-making styles, and potential areas of confusion.

In that regard, the LLM114 would have been trained for multimodal learning. Multimodal learning involves training a model to combine and learn from different data modalities simultaneously. This can be achieved through one or more of early fusion (concatenating features from different modalities into a single input vector for the model), late fusion (training separate models for each modality and then combining their predictions), and hybrid fusion which combines early and late fusion. Furthermore, the LLM 114can analyze text responses and provide context for interpreting biometric and GUI interaction data. For example, if a user expresses confusion in their text response, the LLM 114can analyze their eye movements and GUI interactions to identify the specific elements causing difficulty. In that regard, the assessment module212 may further be configured to convert the employee biometric data into textual format for processing by the LLM 114. Furthermore, in several embodiments, the assessment report 608generated by the assessment module212 may include quantitative scores, qualitative observations, and visualizations to illustrate key findings.

On successful completion of the assessment, the assessment module212 may further be configured to generate a validation certificate 612that may be downloaded by the employee 132 through the GUI module210.There could be several ways in which successful completion of assessment can be gauged. It can be a specific score that the employee has to get during the assessment (like 80%). It could be the number of hours the employee has spent in training (like airline companies do for pilots). It could be the number of modules the employee 132 has completed. It could be asubjective criterion like behavior assessment (by the LLM 114) that can determine thesuccessful completion of training. The validation certificate 612may be used by the employee 132in applying for job confirmation, promotions, or new jobs with other hospitality entities. Furthermore, the recommendation module214 is configured to generate corrective recommendations 610 based on the assessment report 608. In several embodiments, the recommendation module214 may also leverage the LLM 114to generate the corrective recommendations610. The corrective recommendations 610 may include, for example, text-based suggestions, such as “improve your behavior”, “be more courteous”, “learn more about the hotel”, “speak slowly”, and “give all the options to the customers”. The corrective recommendations 610may be displayed by the GUI module210 on the VR headset 130.

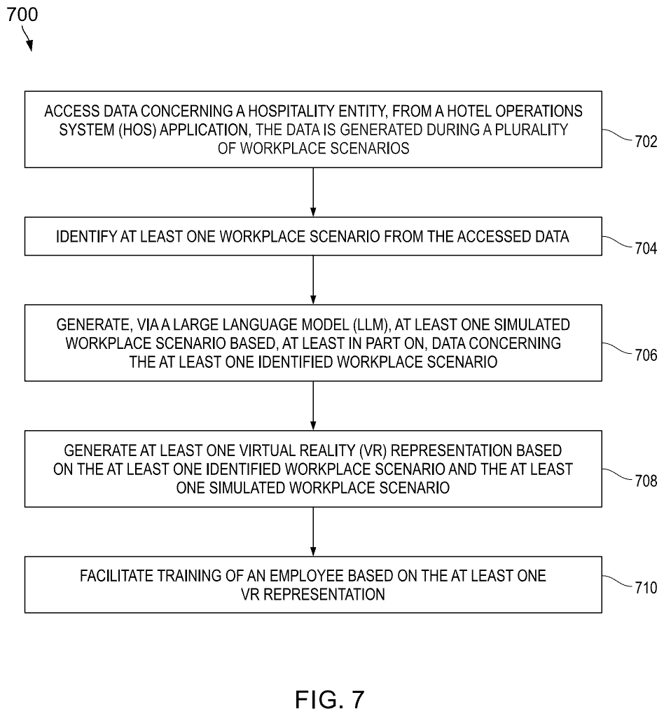

FIG. 7 illustrates a flow diagram depicting a method 700for rendering training assessment in simulated environments, in accordance with an embodiment of the present disclosure. The several steps involved in the method 700 may be performed by the processing circuitry120, such as through the processor 122 executing the machine-readable instructions stored in the memory unit 124or other volatile and non-volatile memory devices provided in the processing circuitry120.For example, the several steps involved in themethod 700 may be performed by the processing circuitry120 by implementing the several modules depicted in FIG. 2, where the several modules communicate with each other through the communication bus 216.

The method begins at Step 702 where the processing circuitry120 is caused to access the data concerning the hospitality entity, from theHOS application110.The data is generated during the plurality of workplace scenarios. In several embodiments, the data 304 is accessed in the form of the plurality of screenshots of the user-interface (UI) of the HOS application 110, from the plurality of employee client devices 102. In several embodiments, the data 304 is accessed from the HOS storage device 108, through the HOS application server 106 using API calls made to the HOS API 303. In that regard, the accessed data 304 may also include video files, audio files, text data, spreadsheets, etc.

For example, the accessed data 304 may include structured data such as guest information, reservation details, room inventory, and financial transactions stored in form of SQL databases, comma separated value (CSV) files, spreadsheets, etc. Furthermore, the accessed data 304 may include guest reviews, feedback forms, internal memos, and other textual information stored as plain text files or in formats like DOCX or PDF. The accessed data 304 may further include photos of guests (for identification purposes), scanned documents (like passports), and images of hotel rooms or facilities stored in formats like JPEG, PNG, or GIF. The accessed data 304 may further include security camera footage, promotional videos, or recordings of events stored in formats like MP4 or AVI. Furthermore, the accessed data 304 may include system logs, application data, and other system-specific information that might be stored in binary format or any other proprietary format. The accessed data 304 may also include semi-structured data stored as JSON (JavaScript Object Notation) or XML (Extensible Markup Language) objects.

At Step 704, the processing circuitry120 is caused to identifythe at least one workplace scenario410 from the accessed data 304. In several embodiments, for identifying the at least one workplace scenario410 the processing circuitry120 is further caused to determine at least one feature indicative of the at least one identified workplace scenario 410. In several embodiments, the at least one feature includes at least one of a type of the at least one identified workplace scenario 410, a duration of the at least one identified workplace scenario 410, and an outcome of the at least one identified workplace scenario 410.

At Step 706, the processing circuitry120 is caused to generate, via the LLM 114, the at least one simulated workplace scenario 460 based, at least in part on, the data concerning the at least one identified workplace scenario 410.The data concerning the at least one identified workplace scenario 410 includes the text-based interactions 402, the numerical data 404, and the time-stamped events 406.

At Step 708, the processing circuitry120is caused to generate the at least one Virtual Reality (VR) representation 502(and/or the VR representation 575) based on the at least one identified workplace scenario 410 and the at least one simulated workplace scenario 460. In several embodiments, the processing circuitry 120 is further caused to include the at least one AI NPC504 (and/or the AI NPC 585) in the at least one VR representation 502 (and/or the VR representation 575).

At Step 710, the processing circuitry120 is caused to facilitate training of the employee 132 based on the at least one VR representation 502. In several embodiments, for facilitating the training of the employee 132, the processing circuitry 120 is further caused to provide the at least one VR representation 502 to the employee on the VR headset 130 associated with the employee132. In several embodiments, the processing circuitry 120 is further caused to receive the employee inputs, such as the messages 602, the responses 604, the interactions 606, from the VR headset 130 in response to the provision of the at least one VR representation502(and/or the VR representation 575). In several embodiments, the processing circuitry 120 is further caused to generate the assessment report 608 indicative of the performance of the employee 130 based on the received employee inputs. In several embodiments, the processing circuitry 120 may further be caused to receive employee biometric data from one or more biometric sensors associated with the employee 130.In such scenarios, the processing circuitry 120 may further be caused to generate the assessment report 608 based on the received employee inputs and the received employee biometric data. In several embodiments, the processing circuitry120 may further be caused to generate corrective recommendations 610 based on the assessment report 608.

The embodiments of the present disclosure as discussed above offer several advantages. For example, by implementing VR representations of identified workplace scenarios and/orsimulated workplace scenarios based on the identifiedworkplace scenarios, the training of the employees/personnel associated with the hospitality entity becomes more immersive and engaging. The managers and supervisors need to spend less time with the employees and more time with their actual job assignments concerning the operations and management of the hospitality entity. Furthermore, training of the employees through VR representation and other technologies discussed in the aforementioned discussion is less dependent upon the skills and the abilities of the managers and the supervisors to impart knowledge to the employees leading to better and more uniform outcomes. Furthermore, the existing training modules can be greatly improved as more and more data is generated during the training of the personnel using initial setups. Furthermore, new and advanced training modules can be developed and deployed at scale automatically through the use of technologies such as AI and ML. In addition, through the use of AI and ML, the training modules can be highly customized, automatically, to suit the individual personalities of the employees without putting significant man-hours into the customization process.

A person skilled in the art would appreciate that although the embodiments disclosed in the present disclosure have been elucidated in the context of a hospitality entity, they can also be implemented in several other industries and associated Data Management Systems (DMS) without departing from the scope of the disclosure. For example, the embodiments may be implemented in the manufacturing industry for training industrial workers on new machines and jobs by creating VR representations of a shop floor. The same can be said about the utility industry and implementations of the disclosed embodiments in a power plant by creating virtualizations of a power plant environment. The embodiments may also be implemented in therepair and refurbish industry by training the respective personnel through creating VR representations of repair workshops. Additionally, the embodiments may be implemented in training athletes for specific sports. For example, a VR training system may be created with the help of data from previous matches or games.

The embodiments may also be implemented in training restaurant waiters and bartenders to train them on a variety of customer interaction scenarios. Similarly, the same concept can be extended to several other industries such as landscaping, construction, home appliances, etc. without departing from the scope of the disclosure. Furthermore, the same concept can be extended to educational technology systems for generating educational modules and imparting education to students, and generating instructor training modules and imparting training to instructors on operating procedures in the educational technology sector. The embodiments can also be extended to services offered by the state such as government entities like law enforcement such as police and paramilitary forces, emergency responders such as firefighters and ambulance services, municipal corporations, judicial services such as courts, and the like.

The disclosed method 700 with reference to FIG. 7, or one or more operations of the system116 may be implemented using software including computer-executable instructions stored on one or more computer-readable media (e.g., non-transitory computer-readable media, such as one or more optical media discs, volatile memory components (e.g., Dynamic Random Access Memory (DRAM) or Statis Random Access Memory (SRAM)), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including Radio Frequency (RF), microwave, and infrared communications), electronic communications, or other such communication means.

Although the disclosure has been described with reference to specific exemplary embodiments, It is to be noted that various modifications and changes may be made to these embodiments without departing from the broad scope of the disclosure. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the system116 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium. The computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein.

In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may include connected logic units, such as gates and flip-flops, and may comprise programmable units, such as programmable gate arrays or processors. The modules described herein may be implemented as either software and/or hardware modules and may be stored in any type of computer-readable medium or other computer storage device.

Various embodiments of the disclosure, as discussed above, may be practiced with steps and/or operations in a different order, and/or with hardware elements in configurations, which are different from those which, are disclosed. Therefore, although the disclosure has been described based on these exemplary embodiments, It is to be noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for rendering training assessments in simulated environments, the method comprising:
accessing, by a processing circuitry, data concerning a hospitality entity, from a Hotel Operations System (HOS) application, wherein the data is generated during a plurality of workplace scenarios;
identifying, by the processing circuitry, at least one workplace scenario from the accessed data;
generating, via a Large Language Model (LLM) by the processing circuitry, at least one simulated workplace scenario based, at least in part on, data concerning the at least one identified workplace scenario;
generating, by the processing circuitry, at least one Virtual Reality (VR) representation based on the at least one identified workplace scenario and the at least one simulated workplace scenario; and
facilitating, by the processing circuitry, training of an employee based on the at least one VR representation.

2. The method as claimed in claim 1, wherein facilitating the training of the employee comprises providing, by the processing circuitry, the at least one VR representation to the employee on a VR headset associated with the employee.

3. The method as claimed in claim 2, further comprising receiving, by the processing circuitry, employee inputs from the VR headset in response to the provision of the at least one VR representation.

4. The method as claimed in claim 3, further comprising generating, by the processing circuitry, an assessment report indicative of performance of the employee based on the received employee inputs.

5. The method as claimed in claim 1, wherein identifying the at least one workplace scenario further comprises determining, by the processing circuitry, at least one feature indicative of the at least one identified workplace scenario.

6. The method as claimed in claim 5, wherein the at least one feature comprises at least one of a type of the at least one identified workplace scenario, a duration of the at least one identified workplace scenario, and an outcome of the at least one identified workplace scenario.

7. The method as claimed in claim 1, further comprising including, by the processing circuitry, at least one Artificial Intelligence based Non-Player Character (AI NPC) in the at least one VR representation.

8. A method for rendering training assessments in simulated environments, the method comprising:
accessing, by a processing circuitry, data concerning a hospitality entity, from a Hotel Operations System (HOS) application, wherein the data is generated during a plurality of workplace scenarios;
identifying, by the processing circuitry, at least one workplace scenario from the accessed data;
generating, via a Large Language Model (LLM) by the processing circuitry, at least one simulated workplace scenario based, at least in part on, data concerning the at least one identified workplace scenario;
generating, by the processing circuitry, at least one Virtual Reality (VR) representation based on the at least one identified workplace scenario and the at least one simulated workplace scenario, and including, by the processing circuitry, at least one Artificial Intelligence based Non-Player Character (AI NPC) in the at least one VR representation;
providing, by the processing circuitry, the at least one VR representation to the employee on a VR headset associated with the employee; and
receiving, by the processing circuitry, employee inputs from the VR headset in response to the provision of the at least one VR representation.

9. The method as claimed in claim 8, further comprising receiving, by the processing circuitry, employee biometric data from one or more biometric sensors associated with the employee.

10. The method as claimed in claim 9, further comprising generating, by the processing circuitry, an assessment report indicative of performance of the employee based on the received employee inputs and the received employee biometric data.

11. A system for rendering training assessments in simulated environments, the system comprising:
a processing circuitry, comprising:
a memory unit comprising machine-readable instructions;
a processor operably connected to the memory unit, the processor configured to execute the machine-readable instructions, the machine-readable instructions when executed by the processor, causes the processing circuitry to:
access data concerning a hospitality entity, from a Hotel Operations System (HOS) application, wherein the data is generated during a plurality of workplace scenarios,
identifyat least one workplace scenario from the accessed data,
generate, via a Large Language Model (LLM), at least one simulated workplace scenario based, at least in part on, data concerning the at least one identified workplace scenario,
generate at least one Virtual Reality (VR) representation based on the at least one identified workplace scenario and the at least one simulated workplace scenario, and
facilitate training of an employee based on the at least one VR representation.

12. The system as claimed in claim 11, wherein for facilitating the training of the employee, the processing circuitry is further caused to provide the at least one VR representation to the employee on a VR headset associated with the employee.

13. The system as claimed in claim 12, wherein the processing circuitry is further caused to receive employee inputs from the VR headset in response to the provision of the at least one VR representation.

14. The system as claimed in claim 12, wherein the processing circuitry is further caused generate an assessment report indicative of performance of the employee based on the received employee inputs.

15. The system as claimed in claim 11, wherein for identifying the at least one workplace scenario, the processing circuitry is further caused to determine at least one feature indicative of the at least one identified workplace scenario.

16. The system as claimed in claim 15, wherein the at least one feature comprises at least one of a type of the at least one identified workplace scenario, a duration of the at least one identified workplace scenario, and an outcome of the at least one identified workplace scenario.

17. The system as claimed in claim 11, wherein the processing circuitry is further caused to include at least one Artificial Intelligence based Non-Player Character (AI NPC) in the at least one VR representation.

18. A system for rendering training assessments in simulated environments, the system comprising:
a processing circuitry, comprising:
a memory unit comprising machine-readable instructions;
a processor operably connected to the memory unit, the processor configured to execute the machine-readable instructions, the machine-readable instructions when executed by the processor, causes the processing circuitry to:
accessdata concerning a hospitality entity, from a Hotel Operations System (HOS) application, wherein the data is generated during a plurality of workplace scenarios,
identifyat least one workplace scenario from the accessed data,
generate, via a Large Language Model (LLM), at least one simulated workplace scenario based, at least in part on, data concerning the at least one identified workplace scenario,
generate at least one Virtual Reality (VR) representation based on the at least one identified workplace scenario and the at least one simulated workplace scenario, and include at least one Artificial Intelligence based Non-Player Character (AI NPC) in the at least one VR representation,
provide the at least one VR representation to the employee on a VR headset associated with the employee, and
receive employee inputs from the VR headset in response to the provision of the at least one VR representation.

19. The system as claimed in claim 18, wherein the processing circuitry is further caused to receive employee biometric data from one or more biometric sensors associated with the employee.

20. The system as claimed in claim 19, wherein the processing circuitry is further caused to generate an assessment report indicative of performance of the employee based on the received employee inputs and the received employee biometric data.
